(19) United States
(12) Patent Application Publication
(10) Pub. No.: US 2004/0081414 A1
(43) Pub. Date: Apr. 29, 2004

(54) Type of optical/RF transmission fiber constructed from left handed materials (LHM) with air core capable of high power transmission

(76) Inventor: Delmar L. Barker, Tucson, AZ (US)

Correspondence Address: COLIN M. RAUFER, RAYTHEON COMPANY, MS E0/E1/E150, P.O. Box 902, El Segundo, CA, 90245-0902, US

(21) Appl. No.: 10/282,502

(22) Filed: Oct. 28, 2002

(51) Int. Cl. G02B 6/02; G02B 6/20

(52) U.S. Cl. 385/125

(57) ABSTRACT

An optical/electromagnetic fiber capable of high power transmission comprises an air core surrounded by a left-handed meta-material (LHM). Conventional optical fibers need more power capacity. While photonic band gap-based optical fibers may be sufficient, left-handed materials provide new options for designers.

### TECHNICAL FIELD

The present invention relates generally to optical fibers, and, more particularly, to the utilization of left handed meta-materials (LHM) in optical fiber applications and/or left handed structures for guiding electromagnetic radiation in optical fibers or other suitable LHM structures for guiding electromagnetic radiation from UV to microwave radiation.

### BACKGROUND ART

Conventional optical fibers are limited in their ability to transmit large energy densities because of their high refractive index core. This is caused by non-linear processes induced when the intensity of the optical beam reaches a critical level. Such conventional optical fibers comprise a high refractive index core and a low index cladding to achieve total internal reflection.

Attempts to overcome this problem include the use of a photonic band gap cladding, in which a hollow air core is surrounded by material possessing a photonic band gap structure. Such a configuration results in a new type of optical fiber that will transport a high intensity laser beam without the failure mode associated with the conventional optical fiber; see, e.g, U.S. Pat. No. 5,802,236, issued Sep. 1, 1998, and entitled “Article Comprising a Micro-Structured Optical Fiber, and Method of Making Such Fiber”. However, this approach is still very new and has not yet been commercialized.

A need remains for an optical fiber that can transmit high power on the order of mega-Watts, primarily in the range of near-infrared (near-IR) frequencies. However, applications for beam weapons in the visible to microwave frequencies with power levels in the mega-Watt region are also needed.

### DISCLOSURE OF INVENTION

In accordance with the present invention, an optical/RF fiber comprising an electromagnetic material for transmission in the optical/RF frequency range is provided. The fiber is capable of high power transmission and comprises an air core surrounded by a left handed meta material.

Also in accordance with the present invention, a method of fabricating the optical/RF transmission fiber is provided. The method comprises:

(a) providing the left-handed meta-material as a cylinder; and

(b) drawing the cylinder to form the fiber.

Conventional optical fibers need more power capacity. While PBG-optical fibers may be sufficient, left handed materials provide new options for designers. Such options include different construction materials that may result in better radiation hardening or less external signal interference. In general, a more rugged design is anticipated. Construction methods would also be different, thereby lowering cost for certain applications. Due to the newness of this field, many other advantages may emerge in time.

### BRIEF DESCRIPTION OF THE DRAWINGS

FIG. 1 is a cross-sectional view of a conventional optical fiber, comprising a core of relatively high refractive index (n₁>1) optical material surrounded by a cladding of relatively low refractive index optical material (n₂<n₁);

FIG. 2 is a cross-sectional view of a prior art photonic band gap optical fiber, comprising a core of air (n=1) surrounded by a cladding of a photonic band gap optical material; and

FIG. 3 is a cross-sectional view of the optical fiber of the present invention, comprising a core of air surrounded by a cladding of a left-handed optical material (n<1).

### BEST MODES FOR CARRYING OUT THE INVENTION

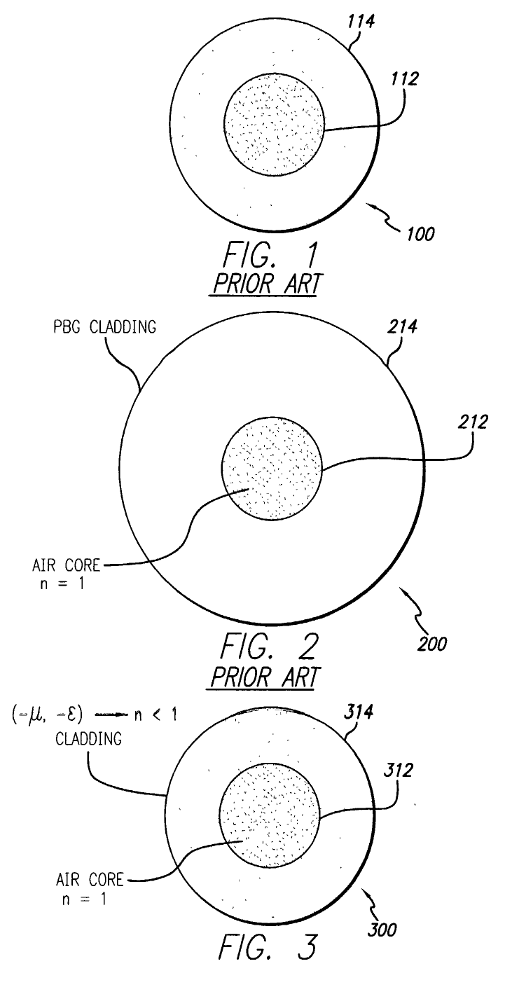

FIG. 1 depicts a conventional optical fiber 100, comprising a core 112 and a cladding 114. As is well-known, the core 112 comprises a first optical material having a first index of refraction n₁ and the cladding 114 comprises a second optical material having a second index of refraction n₂, where n₂<n₁. Both indices of refraction are greater than 1.

FIG. 2 depicts a prior art photonic band gap (PBG) optical fiber 200, comprising a core 212 and cladding 214. In such an optical fiber, the core 212 is air (n=1) and the cladding 214 comprises a photonic band gap optical material. The photonic band gap optical material comprises a dielectric structure with a refractive index that varies periodically in space (in the x-y plane; it is independent of the z-coordinate, i.e., the longitudinal coordinate of the structure), with a period of the order of an optical wavelength (e.g., about 1 to 2 μm).

FIG. 3 depicts the optical fiber 300 of the present invention. As with the PBG optical fiber 200, the core 312 of the present invention is air. However, the cladding 314 comprises a new material, known as left-handed meta-materials (LHM), which has an index of refraction less than 1. Because the LHM cladding 314 has an index of refraction lower than that of the core 312, total internal reflection of an optical signal occurs, allowing transmission of the optical signal along the fiber 300.

In Physics Today, p. 21 (December 1999), it is stated that, since there is no solid material with an index of refraction less than one, then no conventional air (hollow) core fiber that relies on total internal reflection (TIR) is possible.

However, LHM materials have negative index of refraction properties and also pass through the region 0<n<1 to get there. As disclosed by D. R. Smith et al, “Composite Medium with Simultaneously Negative Permeability and Permittivity”, Physical Review Letters, Vol. 84, No. 18, pp. 4184-4187 (May 1, 2000), a composite medium has been demonstrated, based on a periodic array of interspaced, conducting, nonmagnetic split ring resonators (SRR) and continuous wires, that exhibits a frequency region in the microwave regime with simultaneously negative values of effective permeability μ_{eff}(ω) and permittivity ε_{eff}(ω). This structure forms a “left-handed” medium (that is, E×H lies along the direction of −k for propagating plane waves), for which it has been predicted that such phenomena as the Doppler effect, Cerenkov radiation, and even Snell's Law are inverted.

The optical fiber of the present invention comprises a core of empty space, or air, surrounded by the composite medium of, for example, Smith et al, supra, reduced to optical dimensions by conventional mask reduction methods or electron beam integrated circuit construction methods or other known methods for fabricating optical fibers, including, but not limited to, chemical vapor deposition, masking, etc.

For example, the split ring resonator constructed by Smith et al, supra, was evaporated (metal) onto a plastic substrate. A series of masks were placed between the metal vapor beam and the plastic substrate such that a thin layer of copper, in their case, was deposited with the shape of two split, concentric rings.

Another method is to deposit the metal layer and then use a programmed laser beam to remove the material that is unwanted, leaving behind the proper shapes. Two-dimensional layers are made this way and then stacked to create 3-D structures. For cylinder structures, one could roll several layers concentrically. Fibers can be formed by, for example, drawing down a cylinder structure to a smaller diameter, as is known, for example, for conventional optical fibers. All of these concepts can be cleverly automated and computerized by engineers.

Yet another method involves the use of continuous construction of the fiber cable using polymer self-assembly methods.

While the foregoing description has been directed primarily to the fabrication of optical fibers, it is noted that optical, microwave, mm wave, and RF are all forms of electromagnetic radiation, albeit at different wavelengths. Hence, by scaling the construction to smaller and smaller dimensions, the device will transmit shorter and shorter wavelengths (or, conversely, at larger dimensions, the device will transmit longer wavelengths).

In particular, the same materials may be used for optical applications as well as RF applications, with the caveat that efficiency may be lost unless a proper choice of materials is made. However, such a determination is readily within the ability of the person skilled in this art, based on the teachings herein.

### INDUSTRIAL APPLICABILITY

The optical/electromagnetic fiber disclosed and claimed herein is expected to find use in a multitude of applications that use such fibers.

What is claimed is:

1. An optical/RF transmission fiber comprising a hollow core and a cladding surrounding the core, wherein said cladding comprises a left-handed meta-material (LHM), having an index of refraction less than 1.

2. The optical/RF transmission fiber of claim 1 wherein said left-handed meta-material comprises a periodic array of interspaced, conducting, nonmagnetic split ring resonators (SRR) and continuous wires, that exhibits a frequency region in the microwave regime with simultaneously negative values of effective permeability μ_{eff}(ω) and permittivity ε_{eff}(ω).

3. A method of fabricating an optical/RF transmission fiber comprising a hollow core and a cladding surrounding the core, wherein said cladding comprises a left-handed meta-material (LHM), having an index of refraction less than 1, said method comprising:
(a) providing said left-handed meta-material as a cylinder; and
(b) drawing said cylinder to form said fiber.

4. The method of claim 3 wherein said left-handed meta-material comprises a periodic array of interspaced, conducting, nonmagnetic split ring resonators (SRR) and continuous wires, that exhibits a frequency region in the microwave regime with simultaneously negative values of effective permeability μ_{eff}(ω) and permittivity ε_{eff}(ω).
